(19) United States
(12) Patent Application Publication
(10) Pub. No.: US 2023/0259870 A1
(43) Pub. Date: Aug. 17, 2023

(54) METHOD AND SYSTEM FOR MULTI-ENTERPRISE FREIGHT LOAD CONSOLIDATION AND OPTIMIZATION

(71) Applicant: PANDOCORP PRIVATE LIMITED, Chennai (IN)

(72) Inventors: Abhijeet MANOHAR, Bangalore (IN); Siddhant MALHOTRA, New Delhi (IN); Prasad KRISHNAN, Chennai (IN); Krishanu SEAL, Bangalore (IN)

(21) Appl. No.: 17/673,770

(22) Filed: Feb. 16, 2022

(51) Int. Cl. G06Q 10/08

(52) U.S. Cl. CPC G06Q 10/0834

(57) ABSTRACT

A method (500) and server system (200) for multi-enterprise freight load consolidation and optimization is disclosed. Real-freight activity data associated with shippers for delivering shipping consignments within a particular time window is accessed. Shipping delivery clusters are generated based on the real-freight activity data. A first loading plan for consolidating first shipping consignments related to a first shipping delivery cluster into a freight vehicle moving in a forward freight direction is generated based on a first collaborative enterprise policy of the first shipping delivery cluster and first consignee constraints. A second loading plan for consolidating second shipping consignments related to a second shipping delivery cluster into the freight vehicle moving in a reverse freight direction is generated based on a second collaborative enterprise policy of the second shipping delivery cluster and second consignee constraints. The second loading plan increases vehicle utilization for shippers by avoiding an empty return haul.

### TECHNICAL FIELD

The present disclosure generally relates to shipping industry and, more particularly, to a method and system for managing multi-enterprise freight load consolidation to optimize delivery of shipping consignments.

### BACKGROUND

The shipping industry is often plagued with concerns related to waste and inefficiency. One particular concern relates to the problem of freight vehicles returning underutilized after a freight load has been delivered. In addition to the opportunity loss associated with underutilizing freight vehicles, transporting empty freight vehicles wastes fuel, which results in higher costs to the shippers. To address this problem, some shipping companies direct freight vehicles to pick up second shipping consignments at or near locations, where the first shipping consignments are dropped off. However, a large number of freight vehicles still return underutilized as the return haul load management is performed manually using rudimentary tools in absence of a mechanism to take into account shipping consignments from multiple enterprises and their respective loading and shipping constraints.

Accordingly, there is a need to overcome the drawbacks of conventional solutions and provide ways to optimize utilization of freight vehicles for both forward and return hauls. It would also be advantageous to consolidate freight from multiple enterprises to optimize the delivery of shipping consignments.

### SUMMARY

In an embodiment of the invention, a computer-implemented method for multi-enterprise freight load consolidation and optimization is disclosed. The method accesses, by a server system, real-freight activity data associated with a plurality of shippers for delivering a plurality of shipping consignments within a particular time window. Each shipping consignment from the plurality of shipping consignments is associated with a set of transport parameters and delivery constraints. The set of transport parameters includes an origin location, a destination location, and a plurality of relay point locations positioned within a shipping lane. The method generates, by the server system, a plurality of shipping delivery clusters based, at least in part, on the real-freight activity data associated with the plurality of shippers. Each shipping delivery cluster includes a set of shippers configured to transport at least one shipping consignment having at least one transport parameter matched within a threshold boundary value. The method generates, by the server system, a first loading plan for consolidating one or more first shipping consignments related to a first shipping delivery cluster into a freight vehicle moving in a forward freight direction based, at least in part, on a first collaborative enterprise policy of the first shipping delivery cluster, and a plurality of first consignee constraints. The method generates, by the server system, a second loading plan for consolidating one or more second shipping consignments related to a second shipping delivery cluster into the freight vehicle moving in a reverse freight direction based, at least in part, on a second collaborative enterprise policy of the second shipping delivery cluster, and a plurality of second consignee constraints. The second loading plan increases vehicle utilization for the plurality of shippers by avoiding an empty return haul. The method sends, by the server system, one or more notification messages to a fleet management entity associated with the freight vehicle. The one or more notification messages include the first loading plan and the second loading plan for the freight vehicle.

In an embodiment of the invention, a server system for multi-enterprise freight load consolidation and optimization is disclosed. The system includes a processor and a memory. The memory stores instructions. The processor is configured to execute the instructions and thereby cause the server system to at least access real-freight activity data associated with a plurality of shippers for delivering a plurality of shipping consignments within a particular time window. The each shipping consignment from the plurality of shipping consignments is associated with a set of transport parameters and delivery constraints. The set of transport parameters includes an origin location, a destination location, and a plurality of relay point locations positioned within a shipping lane. The server system generates a plurality of shipping delivery clusters based, at least in part, on the real-freight activity data associated with the plurality of shippers. Each shipping delivery cluster includes a set of shippers configured to transport at least one shipping consignment having at least one transport parameter matched within a threshold boundary value. The server system generates a first loading plan for consolidating one or more first shipping consignments related to a first shipping delivery cluster into a freight vehicle moving in a forward freight direction based, at least in part, on a first collaborative enterprise policy of the first shipping delivery cluster, and a plurality of first consignee constraints. The server system generates a second loading plan for consolidating one or more second shipping consignments related to a second shipping delivery cluster into the freight vehicle moving in a reverse freight direction based, at least in part, on a second collaborative enterprise policy of the second shipping delivery cluster, and a plurality of second consignee constraints. The second loading plan increases vehicle utilization for the plurality of shippers by avoiding an empty return haul. The server system sends one or more notification messages to a fleet management entity associated with the freight vehicle, the one or more notification message including the first loading plan and the second loading plan for the freight vehicle.

### BRIEF DESCRIPTION OF THE FIGURES

FIG. 1 illustrates an exemplary representation of an environment related to at least some example embodiments of the present invention;

FIG. 2 is a block diagram of a server system configured to optimize delivery of consignments, in accordance with an embodiment of the invention;

FIG. 3 is a schematic representation for illustrating a process flow for generating loading plans of a freight vehicle for forward freight consolidation and reverse freight consolidation, in accordance with an embodiment of the invention;

FIG. 4 shows a flow diagram for consolidating shipping consignments of multiple shippers in forward freight and reverse freight, in accordance with an embodiment of the invention, in accordance with an embodiment of the invention; and

FIG. 5 shows a flow diagram of a computer-implemented method for multi-enterprise freight load consolidation, in accordance with an embodiment of the invention.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

### Overview

Various embodiments of the present invention provide methods, systems, user devices, and computer program products for facilitating multi-enterprise freight consolidation and optimization. The objective of the present invention is to save cost and improve transporter performance for shippers. The present invention allows consolidation of shipping consignments of different shippers in such a way that the overall freight vehicle utilization (i.e., weight and volume utilization) increases, resulting in reduction of delivery costs.

In an example, the present disclosure describes a server system that provides a loading plan for shipping consignments associated with multiple shippers. At first, the server system is configured to receive real-freight activity data of a plurality of shippers either from a database or from computing devices of the plurality of shippers, over a network. The real-freight activity data of each shipper may include, but is not limited to, information of shipping consignments that are to be delivered within a particular time duration. The server system utilizes custom multi-clustering algorithms to identify the shippers and consignees that can be clubbed together based on the real-freight activity data. A multi-clustering algorithm may use a combination of hierarchical clustering and an iterative K-Means clustering algorithm. The hierarchical clustering is used to identify candidate shippers to form clusters based on the demand profiles, delivery routes and time windows for delivering multiple shipping consignments of the candidate shippers. The iterative K-Means clustering algorithm is used to form clusters of delivery based on the routes and the distance constraints. Based on the final clusters identified from the multi-level clustering method, the server system is configured to run a “meta-heuristic” based method that applies all of the hard constraints in terms of consignee delivery windows, consignee vehicle level restrictions, stacking norms, and loading constraints to ensure that the routes are optimized for lowest distance, least transit and waiting times, lower loading and unloading times and SKU mix to reduce shortage damages. The constraints are configurable and also suggested based on the historical data for the lanes. The base freight charges and all other charges, and the negative penalties for deviations of the soft constraints are summed to compute the total loading plan cost for each simulation, which is then used to determine the lowest loading plan cost.

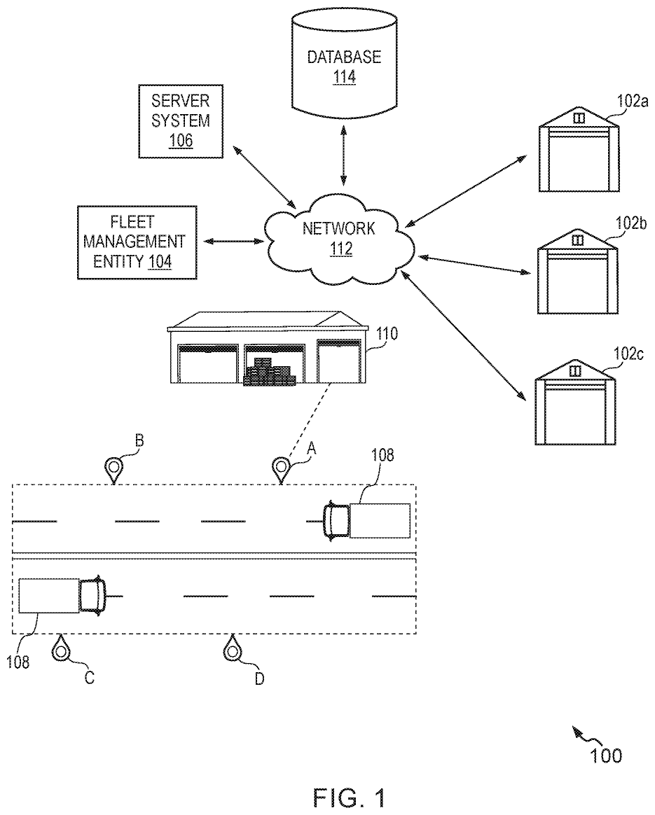

The various embodiments of the present invention are explained next with reference to FIGS. 1 to 5.

FIG. 1 illustrates an exemplary representation of an environment 100 related to at least some example embodiments of the present invention. The environment 100 includes a plurality of shippers 102a, 102b and 102c configured to deliver a plurality of shipping consignments, a fleet management entity 104, a server system 106, each coupled to, and in communication with (and/or with access to) a network 112. The network 112 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among two or more of the parts or users illustrated in FIG. 1, or any combination thereof.

Various entities in the environment 100 may connect to the network 112 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. The network 112 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof. For example, the network 112 may include multiple different networks, such as a private network made accessible by the plurality of shippers 102a-102c, the fleet management entity 104, and the server system 106 and separately, a public network (e.g., the Internet) through which the server system 106 and the fleet management entity 104 may communicate.

Each shipper (e.g., shipper 102a) may be an entity providing freights needing transport. More illustratively, the shipper 102a may be a party receiving shipping consignments from consignors and who arranges for transportation services for the shipping consignments to the intended consignees. Each shipper may have a connection with a warehouse (i.e., warehouse 110 at location point ‘A’ associated with the shipper 102a) owned by an organization (e.g., a manufacturer, an exporter, a retailer, an importer or, in general, a consignor) for stocking shipping consignments before they are distributed. In at least some embodiments, the warehouse 110 may store several consignments or batches of goods to be transported to one or more customers (e.g., consignees) by using a plurality of freight vehicles (e.g., freight vehicle 108). Each shipping consignment may include one or more packages including goods to be delivered to their intended consignees.

It is noted that the term ‘consignee’ as used herein refers to a recipient of at least one package being delivered by a consignor. For example, the consignee may refer to a customer or a client who may be an authorized person to receive the package. It should be noted that, in some example embodiments, there may be more than one warehouse and transportation may involve picking up packages related to a consignment from a plurality of warehouses and dropping off the packages at multiple consignee locations (also referred to herein as ‘drop locations’). It is further understood that the packages may include a variety of goods such as electronic devices, mechanical equipment, books, food items, gift items, raw materials, spare parts related to vehicles or finished goods related to agriculture, textile, manufacturing, and production. Further, it is noted that a location of pickup of packages, such as warehouse 110, is hereinafter interchangeably referred to as a source location or an origin location, whereas a location of dropping off of the packages (i.e., locations associated with the consignees) is hereinafter interchangeably referred to as a destination location or a drop location.

In one embodiment, the freight vehicle 108 exemplarily shown in FIG. 1, may be employed by the fleet management entity 104 for facilitating distribution of goods in a supply chain, for example from a shipper's warehouse (e.g., warehouse 110) to a consignee location, such as a retail store, for example. The freight vehicle tasked with ferrying delivery packages related to the consignments from one or more pickup locations (such as the warehouse 110) to consignees at different drop locations are interchangeably referred to as ‘delivery vehicles’, ‘freight vehicles’ or simply as ‘vehicles’. It is noted that the fleet management entity 104 may include several vehicles of different structure, capacity and dimensions for transporting cargo with different material characteristics. In some embodiments, each freight vehicle can correspond to any vehicle that is capable of carrying a shipment load. By way of example, freight vehicles can include tractor units (sometimes referred as to as “semis” or “semi-tractors”), flatbed trucks, cargo vans, box trucks, and numerous types of specialized trucks (e.g., tank trucks to carry flammable liquid, refrigerated trucks, etc.). While one fleet management entity 104 is described as providing the transportation service, it is anticipated that some loads will involve plural shipments. These plural shipments may be performed by one fleet management entity or may be performed by multiple fleet management entities.

In many cases, the fleet management entity 104 uses “shipping lanes”, which are origin-destination (consignor-consignee) pairs, generally identified by the general geographical areas of the origin and destination rather than the specific location of the origin or destination. Nevertheless, the “shipping lane” may vary in its specificity, depending on a number of factors. For example, if a long distance haul is performed, the fleet management entity 104 may be willing to extend the definition of the shipping lane to cover larger geographic areas for the origin and destination in order to have an easier time to find a return (i.e., backhaul) load. To use a specific non-limiting example, if the fleet management entity 104 is providing services between New York and San Francisco, an origin or destination in Philadelphia may be within the scope of the shipping lane, but over a shorter distance (such as Boston to New York), Philadelphia may be a significant diversion from a shipping lane whose terminus is New York.

In an example scenario, the shipper 102a may request services of the fleet management entity 104 to deliver one or more shipping consignments to different consignee locations. The shipper 102a may provide order related information, for example, number of consignees, package information related to each consignee, one or more consignee constraints such as package stacking constraints, etc. to the fleet management entity 104. The information related to individual packages may include information, such as dimensions of each package (such as for example volume of a delivery package), weight of each delivery package, package content, and the like. In at least one embodiment, information such as package dimensions, weight of the package, etc., may be captured using sensors installed at various locations of consignor location, such as the warehouse 110. Alternatively, such information may also be captured by sensors deployed at a facility associated with the fleet management entity 104.

In one embodiment, the server system 106 is configured to receive real-activity freight data of a plurality of shipping consignments from the plurality of shippers 102a-102c. The plurality of shipping consignments is to be delivered within a particular time duration (e.g., next two days). The real-freight activity data may include a set of transport parameters and delivery constraints associated with each shipping consignment. The set of transport parameters may include origin location, destination location, and a plurality of relay point locations positioned within a shipping lane. Thus, the real-freight activity data may include parametric information about a shipping consignment such as, a shipment loading location, a loading time (e.g., time interval when load is available for loading), a delivery location, and a delivery time window (e.g., time interval when load is to be delivered at delivery location).

In at least some embodiments, the server system 106 is configured to receive information related to the available vehicles at the facility associated with the fleet management entity 104 over the network 112. In one embodiment, vehicular information, real-freight activity data including shipping consignment information, consignee information, consignee constraints, and loading constraints are stored in a database 114. Some examples of the loading constraints may include, but are not limited to, package stacking rules (i.e., rules that define which packages can be placed in which orientations and what weighing capacities can be put above them), package combination rules (i.e., rules that define which packages can be shipped together and which packages cannot be shipped together due to reasons such as material shelf-life, fragile nature of transported goods, etc.), limits on loading and unloading time and labor costs, and the like. Some examples of consignee constraints may include destination characteristics (i.e., that define criteria related to which packages of a destination location can be combined with packages of another destination locations), preferred delivery routes, delivery window, and the like.

Based on the movement of shipping consignments of different shippers, the server system 106 is configured to identify different shipping lanes which have high probability of freight consolidation going in the same direction. This is done by predicting nearby source points and nearby destination points of different shippers which also have shipped materials on a nearby date. In this scenario, vehicle utilization increases by combining multiple partial truck load (PTL) orders to a few full truck load (FTL) orders.

The server system 106 may be configured to generate loading plans for forward freight shipping lane and/or reverse freight shipping lane of the freight vehicle 108 based on the real-freight activity data of the plurality of shippers and a plurality of consignee constraints.

In one embodiment, the server system 106 is configured to determine reverse freight load consolidation opportunity based on forward transit time required in reaching the destination of the forward freight shipping lane. If the reverse freight is looking at consolidating demand for a particular day, the server system 106 is configured to determine the reverse freight load consolidation opportunity based on the vehicle's capacity as the available capacity for the consolidated demand back from that destination after considering the forward leg's expected date of arrival at that destination.

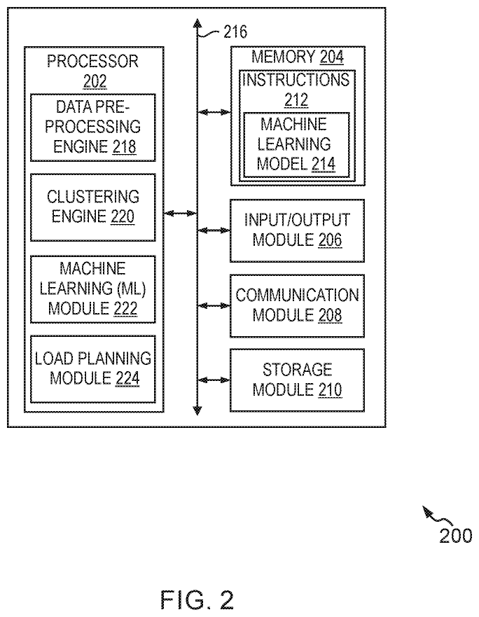

In an illustrative example, the freight vehicle 108 is adapted to deliver shipping consignments of shippers A and B to consignee locations in the forward freight shipping lane. In one embodiment, the fleet management entity 104 is configured to instruct one or more loading personnel (not shown) associated with the fleet management entity 104 to perform loading of the plurality of packages into the plurality of vehicles according to the loading plan generated by the server system 106. The server system 106 configured to generate the load plan for minimizing the overall delivery cost for delivery consignments is explained next with reference to FIG. 2.

The server system 106 may be implemented as a centralized or a distributed server system capable of being accessed over a communication network, such as the network 112. In some embodiments, the server system 106 may be associated with the fleet management entity 104 itself. Alternatively, the server system 106 may be associated with a third-party freight management entity (not shown in FIG. 1), which is configured to provide the services of the server system 106 in exchange for a fee.

FIG. 2 is a block diagram of a server system 200, in accordance with an embodiment of the invention. The server system 200 is an example of the server system 106. In some embodiments, the server system 200 is embodied as a cloud-based and/or SaaS-based (software as a service) architecture.

The server system 200 is configured to facilitate and optimize multi-enterprise freight load consolidation. More specifically, the server system 200 is configured to facilitate consolidation of one or more shipping consignments from multiple shippers in a freight vehicle (or more than one freight vehicle) to be delivered along one direction, referred to herein as the ‘forward freight direction’. Further, the consolidation of one or more shipping consignments in the forward freight direction is referred to herein as ‘forward freight consolidation’. On the return leg of the freight vehicle, which is referred to herein as the ‘reverse freight direction’, one or more shipping consignments from a same or different set of shippers may similarly be consolidated in the freight vehicle (or more than one freight vehicle) and such consolidation of the one or more shipping consignments in the reverse freight direction is referred to herein as the ‘reverse freight consolidation’. It is noted that the return leg of the freight vehicle, i.e., the route taken by the freight vehicle when returning from the destination location may be the same or different than the route taken by the freight vehicle during the forward leg of the freight vehicle. More specifically, the path followed by the freight vehicle in the reverse freight direction and the forward freight direction may be exactly the same (i.e., follow the same relay points when traversing the path from the source location to the destination location and back). Alternatively, the path followed by the freight vehicle in the reverse freight direction and the forward freight direction may be different (i.e., follow different relay points when traversing the path from the source location to the destination location and back). In some scenarios, the freight vehicle may also return to a location nearby the source location (or any location determined by the fleet management entity) when traversing the return path from the destination location. It is further noted that the terms ‘freight load’ and ‘freight’, are used interchangeably hereinafter.

The server system 200 includes at least one processor 202 for executing instructions, a memory 204, input/output module 206, a communication module 208, and a storage module 210 that communicate with each other via a centralized circuit system 216.

The processor 202 includes suitable logic, circuitry, and/or interfaces to execute operations for managing multi-enterprise freight consolidation in forward freight direction and reverse freight direction. Examples of the processor 202 include, but are not limited to, an application-specific integrated circuit (ASIC) processor, a reduced instruction set computing (RISC) processor, a graphical processing unit (GPU), a complex instruction set computing (CISC) processor, a field-programmable gate array (FPGA), and the like. The processor 202 includes a data pre-processing engine 218, a clustering engine 220, a machine learning (ML) module 222, and a load planning module 224. It should be noted that the components, described herein, can be configured in a variety of ways, including electronic circuitries, digital arithmetic and logic blocks, and memory systems in combination with software, firmware, and embedded technologies.

The memory 204 includes suitable logic, circuitry, and/or interfaces to store a set of computer-readable instructions for performing operations. The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash memory, RAM (random access memory), etc.), magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc) and BD (BLU-RAY® Disc).

In at least some embodiments, the memory 204 stores the instructions 212 which may be used by modules of the processor 202 such as the clustering engine 220, the machine learning module 222, and the load planning module 224. For example, the instructions 212 stored in the memory 204 include code/instructions related to one or more machine learning models, such as recurrent neural network models (e.g., multi-layered LSTM neural network models), which are capable of being trained for predicting demand profiles of the plurality of shippers in near real-time. Though the memory 204 is depicted to include only one ML model 214, it is noted that the memory 204 may include other machine learning models, heuristic algorithms and the like.

As explained above, the memory 204 also stores code/instructions, which are used by the load planning module 224. In at least some embodiments, the load planning module 224 may use the instructions stored in the memory 204 to generate a loading plan for forward freight direction as well as reverse freight direction based on inputs provided by the plurality of shippers.

The data pre-processing engine 218 includes suitable logic and/or interfaces for accessing real-freight activity data associated with a plurality of shipping consignments from the plurality of shippers 102a-102c. In one example, the real-freight activity data may include general descriptions of the shipping consignments, origin locations, destination locations, time of availability of the load, timing windows for pick-up and delivery, weight, physical dimensions or other relevant attributes of the shipping consignments, etc. More particularly, each shipping consignment is associated with a set of transport parameters.

The clustering engine 220 is configured to create one or more shipping delivery clusters based at least on the real-freight activity data associated with the plurality of shippers and a clustering model. In other words, the plurality of shippers is grouped into the one or more shipping delivery clusters. Each shipping delivery cluster has a set of shippers configured to deliver at least one shipping consignment with at least one matched transport parameter matched within a threshold boundary value. For example, for the transport parameter ‘origin location’, if consignment pickup for two different shippers in a given time window (say 2 days) is within a threshold boundary value of ‘2 miles’, then such shipping consignments may be consolidated and accordingly, the shipper may added to a common shipping cluster. It is accordingly understood that the term ‘threshold boundary value’ as used herein implies ‘a permissible range of difference between transport parameters associated with two different shipping consignments’. In another illustrative example, for the transport parameter ‘destination location’ if consignment delivery for two different shippers in a given time window (say 2 days) is within a threshold boundary value of ‘5 miles’, then such shipping consignments may be consolidated and accordingly, the shipper may added to the shipping cluster.

In one example, the clustering model may implement multi-level clustering algorithm to identify candidate shippers which can be grouped into a shipping delivery cluster based on demand profiles of the candidate shippers and delivery routes and delivery sliding windows for multiple shipping consignments of the candidate shippers.

“Clustering” generally refers to a process of grouping a set of data or objects (e.g., shippers, consignees, etc.) into a set of meaningful sub-classes called “clusters” according to a natural grouping. Clustering generally is a form of data mining or data discovery used in unsupervised machine learning of unlabeled data.

In one embodiment, the clustering engine 220 is configured to take transport parameters and other characteristic information (such as, nearby locations of multiple shippers, consignee locations, shipping lanes, etc.) as inputs to identify the one or more shipping delivery clusters. The clustering characteristic points may be location information relating to a shipper, location information relating to a shipping consignment (e.g., a departure location, a destination, etc.), location information determined by other information, the like, or any combination thereof. In some embodiments, the clustering characteristic point may represent a departure location of a shipping consignment. In one example, a shipping delivery cluster may correspond to shippers with concentrated locations.

In one embodiment, the clustering model may be a divisive clustering algorithm, a hierarchical clustering algorithm, a density-based clustering algorithm, a model-based clustering algorithm, and the like, or any combination thereof. The divisive clustering algorithm may include, but is not limited to, a K-means clustering algorithm, a clustering algorithm based on division (e.g., FCM (Fuzzy C-Means)), etc. In some embodiments, the divisive clustering algorithm may first create K clusters. Then, an object may be moved from one cluster to another by cyclic positioning technology to improve the results of the divisions. The K divisions may be a result of self-adaptive calculation. The hierarchical clustering algorithm may include, but is not limited to, a BIRCH (balanced iterative reducing and clustering using hierarchies) algorithm, a CURE (clustering using representatives) algorithm, a ROCK (robust clustering using links) algorithm, and the like, or any combination thereof. In some embodiments, the hierarchical clustering algorithm may employ a top-down or a bottom-up operating method.

For example, the shippers in Beijing may be clustered according to coordination information of all shipping consignments (that are received by the shippers) within a week. As another example, the shippers in Beijing may be divided into 50 different shipping delivery clusters according to the transport parameters of all the shipping consignments.

In one embodiment, the machine learning (ML) module 222 is configured to predict demand profiles associated with each shipper for the particular time duration based, at least in part, on a machine learning model. In one non-limiting example, the machine learning model is multi-layered Long Short Term Memory (LSTM) neural network model. The ML module 222 is configured to learn historical traffic pattern data corresponding to each shipping lane (e.g., forward leg and reverse leg) to predict demand profiles for shipping consignments related to each shipper across all shipping lanes. The hidden patterns within long sequences of historical freight data of the plurality of shippers across a number of shipping lanes may include varying demand profiles corresponding to individual shipping consignment sent to various consignees across various destination locations. To decode the hidden patterns, the neural network model is configured to learn latent time structure of historical freight data of the plurality of shippers for predicting demand profiles in the future.

More illustratively, the ML module 222 is configured to determine future shipping consignment pattern data of the plurality of shippers so that proactive decision making can be done for freight consolidation. Based on the movement of shipping consignments of different shippers, the ML module 222 is configured to predict nearby source points and nearby destination points of different shippers which also have shipping consignments on a nearby date.

In some embodiments, the machine learning model may include supervised learning, unsupervised learning, semi-supervised learning, reinforcement learning, etc. According to different algorithms, methods of the machine learning model may include regression algorithm learning, example-based learning, formal learning, decision tree learning, Bayesian learning, clustering algorithm learning, association rule learning, neural network learning, deep learning, dimensionality reduction algorithm learning, etc. More particularly, for example, exemplary regression algorithm models may include ordinary least-square, logistic regression, stepwise regression, MARS (multivariate adaptive regression splines), locally estimated scatterplot smoothing; and the example-based-models may include k-nearest neighbor, learning vector quantization, SOM (self-organizing map), etc. Exemplary formal learning models may include RIDge Regression, LASSO (least absolute shrinkage and selection operator or elastic net) etc. Decision tree models may include classification and regression trees, random forest, GBM (gradient boosting machine), etc. Exemplary Bayesian models may include naive Bayesian algorithm and averaged one-dependence estimators, BBN (Bayesian belief network), etc.

The load planning module 224 is configured to generate a loading plan for consolidating a set of shipping consignments of different shippers into a freight vehicle based at least on shipping delivery clusters and a plurality of consignee constraints. In one embodiment, the load planning module 224 is configured to create loading plans for both the forward freight direction and the reverse freight direction.

In one embodiment, the plurality of consignee constraints may include consignee operating hours for reducing a vehicle wait time of the plurality of shippers, consignee vehicle level restrictions based on the plurality of consignee locations for ensuring vehicle access, stock keeping unit (SKU) mix to ensure that consignments with varying material properties are not transferred together in a vehicle, consignee delivery windows, etc.

The term ‘loading plan’ as used herein refers to a plan or a strategy that includes a sequence of loading actions to be performed to achieve the objective of delivering the plurality of packages with the minimum cost, while taking into consideration the plurality of constraints. In one embodiment, the loading plan outlines: (1) the number of shipping consignments that can be accommodated into the freight vehicle, (2) the vehicle type and vehicle model, (3) the identification of which package goes to which destination location and needs to be accommodated in which vehicle, (4) the sequence of loading and optimal placement of the packages in each vehicle selected for delivery, (5) the number of consignees to deliver to, the number of drop locations and a route to be followed by each selected vehicle, and (6) a listing of stacking, loading and unloading constraints associated with the delivery of packages related to the consignment delivery.

At first, the load planning module 224 is configured to select a freight vehicle 108 of the fleet management entity 104 based at least on material densities of the shipping consignments, origin and destination information, time constraints, and other requirements and preferences of the shippers (e.g., shipper 102a). Sometimes, the shipper 102a may define collaborative enterprise policies for sharing shipping businesses with other shippers or for sharing the freight vehicle for delivering the shipping consignments. Hence, the load planning module 224 also considers collaborative enterprise policies set by the shippers across different shipping lanes. According to the collaborative enterprise policy, the shipper's shipping consignments must consist of a particular quantity, to allow for freight consolidation. For example, on a given shipping lane, for a given date, a particular shipper may only contribute 20% of the capacity of the freight vehicle, while other shippers contribute to the remaining 80% of the vehicle capacity. Accordingly, a first collaborative enterprise policy may be generated by the load planning module 224, which includes a set of predefined rules for forward freight consolidation defined by shippers included in the first shipping delivery cluster. More specifically, the individual collaborative enterprise policies defined by the shippers selected in the first shipping delivery cluster may configure the first collaborative enterprise policy. An example of a predefined rule is a load contribution percentage of the shipper to the total freight load ferried by the freight vehicle. Another example of the predefined rule may include a restriction of type of materials from other shippers that can be transported with a shipper's consignments. Similar to the first collaborative enterprise policy, a second collaborative enterprise policy may also be generated by the load planning module 224, which includes a set of predefined rules for reverse freight consolidation defined by shippers included in the second shipping delivery cluster. More specifically, the individual collaborative enterprise policies defined by the shippers selected in the second shipping delivery cluster may configure the second collaborative enterprise policy. Further, the first and the second collaborative enterprise policies may also include other clauses such as, legal requirement, insurance policies, and acceptable safety record. Additional considerations include necessary turn-around time for the freight vehicle at sequential destinations and origins. These turn-around times are dependent on the physical capabilities and local distances between depots. The load planning module 224 is configured to determine consolidation opportunity across time looking at aggregation opportunities across other shippers' shipping consignments on a daily basis.

For forward freight consolidation, i.e., freight consolidation in the forward freight direction, the load planning module 224 is configured to aggregate the predicted demand profiles of a set of shippers included in a first shipping delivery cluster with one or more shipping consignments received in the real-freight activity data. Based on the aggregation for the forward freight consolidation, the load planning module 224 is configured to determine a probability of re-sizing the freight vehicle to make full truck load (FTL) from partial truck load (PTL). Hence, every opportunity to upsize the freight vehicle to a higher vehicle capacity is considered to accommodate the combined load demand Thus, the load planning module 224 may provide real-time recommendation to the fleet management entity 104 to select a freight vehicle that can accommodate the aggregated demand and any excess inventory for subsequent days. Conversely, the load planning module 224 is configured to pull demand from the following day(s), while attempting to upsize the dispatch to the next higher vehicle capacity.

In one example, the shipper in question may not have negotiated contracts for that particular vehicle type for that lane. In the case where demand is being pushed out to following days, the load planning module 224 factors in the destination inventory view, and can optionally factor in the statistically modelled view of the potential loss in sales of those items being pushed out to later. The load planning module 224 while consolidating the load across shippers also considers the consignee operating hours to make sure the wait time for the transporters is minimal. Further, in at least some embodiments, ‘a maximum waiting time’ associated with each shipper for freight consolidation and loading constraints is obtained from the respective shipper (or in some cases, a default time value in hours may also be considered). The maximum waiting time is used like a threshold criterion when considering consolidating of shipping consignments from different shippers. Furthermore, in both forward and reverse freight consolidation, the restrictions at a truck type level based on the consignee location are adhered. The freight consolidation for both the forward and reverse freight directions also considers the historical traffic and transit times to make the best guess of actual travel time in real time to ensure lower transit times. The load plan for consolidation is also configured to ensure that the stacking norms set at each delivery/material level are adhered to minimise the damages. The load plan is also configured to ensure that the arrangement of materials is optimised for minimal loading and unloading time. All permissible routes are considered while consolidation and the best possible route to reduce the overall distance travelled is suggested.

The load planning module 224 is configured to select the freight vehicle from the available freight vehicles based, at least in part, on loading characteristics of the freight vehicle and a current location of the freight vehicle. One example of a loading characteristic of the freight vehicle corresponds to a material density, i.e., a weight and a volume of consignments, capable of being accommodated in the freight vehicle. More specifically, the freight vehicle is selected from the available freight vehicles based on material densities associated with the one or more shipping consignments in the forward freight direction (also referred to herein as ‘first shipping consignments) and the material density capable of being accommodated in the freight vehicle. Some other examples of loading characteristics of the freight vehicle include a shape of the loading bin, the physical dimensions of the loading bin, the capability to transport liquid consignments, the capability to provide refrigerate a consignments, and the like. The load planning module 224 is configured to match available material density in the freight vehicle with material densities of the one or more shipping consignments to be shipped when selecting the freight vehicle. To this effect, in some embodiments, the net physical dimensions (height and weight for example) and the net weight of the consolidated freight load may be matched with the physical dimensions of the loading bin of the freight vehicle and rated weight carrying capacity of the freight vehicle when selecting the freight vehicle. In at least some embodiments, the freight vehicle is selected from the available freight vehicles such that the maximum weight and volume utilization is maximized.

The load planning module 224 is further configured to utilize meta-heuristic methods that are applied over the plurality of consignee constraints and other constraints to ensure the routes are optimized for lowest distance, least transit and wait times, lower loading and unloading times and SKU mix to reduce shortage damages. These constraints are configurable and suggested based on historical data for the shipping lanes. The load planning module 224 is configured to simulate various loading plans and determine the total plan costs for the simulated loading plans based on total plan cost for each lane (i.e., forward and reverse freight) including base freight charges (such as for example, a constant charge for deploying the freight vehicle for a limited period of time), all other charges (including fuel charges, toll charges, special material handling charges, etc.) and negative penalties for deviations of the plurality of consignee constraints. Based on the total plan costs for simulated loading plans, the load planning module 224 is configured to find an optimal loading pan in lowest possible time for real-time delivery planning. Further, load consolidation in both forward and reverse direction is configured to accommodate demand from intermediate sources, as well as pick-up freight destined for intermediate destinations along the designated route.

Thereafter, the load planning module 224 is configured to send the loading plan to the fleet management entity 104. The loading plan may be textual document including image graphics, such as the 3D representation and the grid structure, to enable a loader to follow the instructions provided in the loading plan and accordingly load the one or more shipping assignments into the freight vehicle from different origin locations. The loading of the packages in select vehicles as per the loading plan not only ensures 3D-fitment of all the packages within the vehicles with maximum efficiency but also ensures a minimum number of vehicles and a minimum number of consignees and drop locations that each vehicle delivers to, thereby optimizing the cost of delivering the consignment.

The server system 200 also includes an input/output module 206 (hereinafter referred to as an ‘I/O module 206’) and at least one communication module such as a communication module 208. In an embodiment, the I/O module 206 may include mechanisms configured to receive inputs from and provide outputs to the user of the server system 200. To that effect, the I/O module 206 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like.

In an example embodiment, the processor 202 may include I/O circuitry configured to control at least some functions of one or more elements of the I/O module 206, such as, for example, a speaker, a microphone, a display, and/or the like. The processor 202 and/or the I/O circuitry may be configured to control one or more functions of the one or more elements of the I/O module 206 through computer program instructions, for example, software and/or firmware, stored on a memory, for example, the memory 204, and/or the like, accessible to the processor 202.

The communication module 208 may include communication circuitry such as for example, a transceiver circuitry including antenna and other communication media interfaces to connect to a wired and/or wireless communication network. The communication circuitry may, in at least some example embodiments, enable reception/transmission of information from remote network entities, such as real-freight activity data of the plurality of shippers or the database 114 (shown in FIG. 1) that is configured to maintain real-time information related to consignment delivery orders such as, number of packages, package dimensions, consignee information, number of available vehicles, vehicle capacity, etc.

In at least one example embodiment, the communication module 208 is configured to receive real-order data in relation to delivering a consignment including a plurality of packages. The plurality of packages is to be delivered from at least one pickup location, such as the warehouse 110 (shown in FIG. 1), to a plurality of drop locations associated with a plurality of consignees. In at least one embodiment, the real-order data includes package related information corresponding to the plurality of packages and vehicle related information corresponding to a plurality of vehicles available for delivering the consignment.

The communication module 208 is configured to forward the real-order data to the processor 202. The modules of the processor 202 in conjunction with the instructions stored in the memory 204 may be configured to process the real-order data and generate an optimal loading plan for the consignment delivery, i.e. a loading plan that maximizes capacity utilization of vehicle and/or minimizes a delivery cost of delivering the one or more packages associated with the consignment.

The server system 200 also includes a storage module 210, which may be embodied as any computer-operated hardware suitable for storing and/or retrieving data. In one embodiment, the storage module 210 is configured to store information related to previous delivery consignments, such as the number of number of consignees, number of packages delivered to each consignee, the package dimensions, the number of vehicles deployed, the route followed, the placement of packages within each vehicle and a sequence of loading the packages, etc. The information related to previous delivery consignments, i.e. historical orders, is referred to hereinafter as historical-order data. The storage module 210 may also store information related to the machine learning model type, the machine learning model objective, and the like.

The storage module 210 may include multiple storage units such as hard disks and/or solid-state disks in a redundant array of inexpensive disks (RAID) configuration. In some embodiments, the storage module 210 may include a storage area network (SAN) and/or a network attached storage (NAS) system. In one embodiment, the storage module 210 may correspond to a distributed storage system, wherein individual databases are configured to store custom information, such as, information related to the machine learning model type, the machine learning model objective, and the like. Though the storage module 210 is depicted to be integrated within the server system 200, in at least some embodiments, the storage module 210 is external to the server system 200 and may be accessed by the server system 200 using a storage interface (not shown in FIG. 2). The storage interface is any component capable of providing the processor 202 with access to the storage module 210. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the storage module 210.

In one embodiment, various components of the server system 200, such as the processor 202, the memory 204, the I/O module 206, the communication module 208 and the storage module 210 are configured to communicate with each other via or through a centralized circuit system 216. The centralized circuit system 216 may be various devices configured to, among other things, provide or enable communication between the components of the server system 200. In certain embodiments, the centralized circuit system 216 may be a central printed circuit board (PCB) such as a motherboard, a main board, a system board, or a logic board. The centralized circuit system 216 may also, or alternatively, include other printed circuit assemblies (PCAs) or communication channel media.

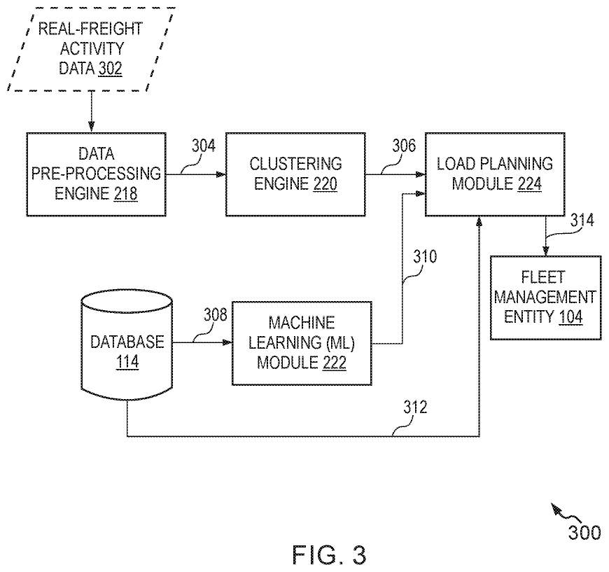

FIG. 3 is a schematic representation 300 for illustrating a process flow for generating loading plans of a freight vehicle for forward freight consolidation and reverse freight consolidation, in accordance with an embodiment of the invention. It is noted that forward freight consolidation implies consolidating one or more shipping consignments for delivering in the forward freight direction, whereas reverse freight consolidation implies consolidating one or more shipping consignments for delivering in the reverse freight direction (i.e., in the return haul of the freight vehicle).

At first, the data pre-processing engine 218 is configured to receive real-freight activity data (see, 302) from the plurality of shippers related to a particular time duration as an input. The real-freight activity data 302 may be associated with a plurality of shipping consignments that is to be delivered with the particular time duration. The real-freight activity data may include, but is not limited to, a set of transport parameters and delivery constraints (such as, delivery time window, etc.) associated with each shipping consignment. The set of transport parameters includes an origin location, a destination location, and a plurality of relay point locations positioned within a shipping lane. The data pre-processing engine 218 is configured to aggregate demand profiles of the plurality of shippers according to one or more rules such as shipping lanes, origin locations, and destination locations, etc. In one embodiment, the data pre-processing engine 218 is also configured to create a sequence of dispatch data for each shipper for a particular shipping lane based, at least in part, on the historical traffic pattern data and the shipping demand at the shipper. The data pre-processing engine 218 is configured to provide the aggregated demand profiles of the plurality of shippers (see, 304) to the clustering engine 220.

The clustering engine 220 is configured to generate a plurality of shipping delivery clusters based on the aggregated demand profiles of the plurality of shippers. More illustratively, for creating a single shipping delivery cluster, the clustering engine 220 is configured to identify a set of shippers having shipping consignments with at least one almost similar transport parameter. For an example, a set of shippers may have shipping consignments from the same geographical area and they need to be delivered in the same shipping route or lane. In another example, the set of shippers may have the shipping consignments from intermediate origin locations in the same shipping lane.

In yet another example, when a shipping consignment of a particular shipper has pick-up location and the destination location within a threshold distance or time from the shipping lane, the particular shipper can be added into the shipping delivery cluster associated with the shipping lane.

The ML module 222 is configured to predict demand profiles of the plurality of shippers for upcoming weeks or months across all the shipping lanes by receiving historical traffic pattern data and delivery transit times from the database 114 (see, 308).

The load planning module 224 is configured to take the shipping delivery clusters, predicted demand profiles of the plurality of shippers and a plurality of consignee constraints as inputs (see, 306, 310, and 312) from the clustering engine 220, the ML module 222 and the database 114, respectively. The load planning module 224 selects a shipping delivery cluster including a set of shippers having one or more shipping consignments to be delivered in the same shipping lane. The load planning module 224 identifies the common end location and initial location of the shipping lane based on origin and destination locations of the set of shippers.

The load planning module 224 is configured to simulate a plurality of episodes iteratively based on a meta-heuristic method. Each episode from among the plurality of episodes entails a probable combination of consolidation of shipping consignments associated with the first shipping delivery cluster. The load planning module 224 is configured to determine the loading plan associated with a lowest loading plan cost for the freight load consolidation based on the simulation of the plurality of episodes. The lowest loading plan cost is computed by summing base freight charges and negative penalties for deviations of the plurality of consignee constraints and the loading constraints.

In one embodiment, the load planning module 224 is configured to send (see, 314) one or notification messages to the fleet management entity 104 about loading plans of forward freight and reverse freight consolidation for the freight vehicle 108.

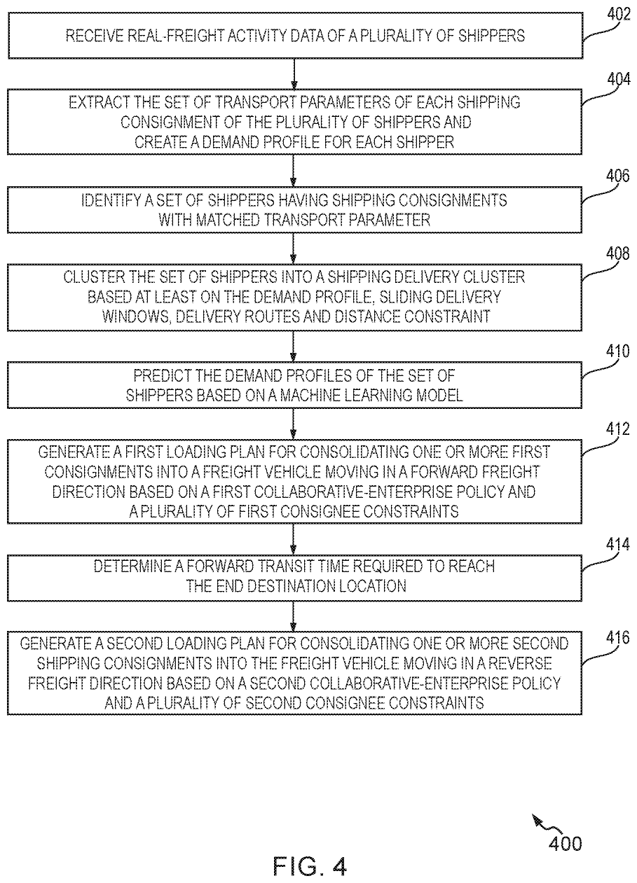

FIG. 4 shows a flow diagram 400 for consolidating forward freight and reverse freight shipping consignments of multiple shippers, in accordance with an embodiment of the invention. The sequence of operations of the flow chart 400 may not be necessarily executed in the same order as they are presented. Further, one or more operations may be grouped and performed in the form of a single step, or one operation may have several sub-steps that may be performed in parallel or in a sequential manner

At 402, the server system 200 receives real-freight activity data of a plurality of shippers. The real-freight activity data may be associated with a plurality of shipping consignments that is to be delivered with the particular time duration. The real-freight activity data may include, but is not limited to, a set of transport parameters and delivery constraints (such as, delivery time window, etc.) associated with each shipping consignment. The set of transport parameters includes an origin location, a destination location, and a plurality of relay point locations positioned within a shipping lane.

At 404, the server system 200 extracts the set of transport parameters of each shipping consignment of the plurality of shippers and creates a demand profile for each shipper.

At 406, the server system 200 identifies a set of shippers having shipping consignments with matched transport parameter.

At 408, the server system 200 clusters the set of shippers into a shipping delivery cluster based at least on the demand profile, sliding delivery windows, delivery routes and distance constraint.

At 410, the server system 200 predicts the demand profiles of the set of shippers based on a machine learning model.

At 412, the server system 200 generates a first loading plan for consolidating one or more first shipping consignments into a freight vehicle moving in a forward freight direction based on a first collaborative enterprise policy and a plurality of first consignee constraints.

At 414, the server system 200 determines forward transit time required to reach end destination location of the forward freight.

At 416, the server system 200 generates a second loading plan for consolidating one or more second shipping consignments into the freight vehicle moving in a reverse freight direction based on a second collaborative enterprise policy and a plurality of second consignee constraints. In at least some embodiments, the second loading plan is generated based on a forward transit time of the freight vehicle required for delivering the one or more first shipping consignments and available vehicle capacity of the freight vehicle.

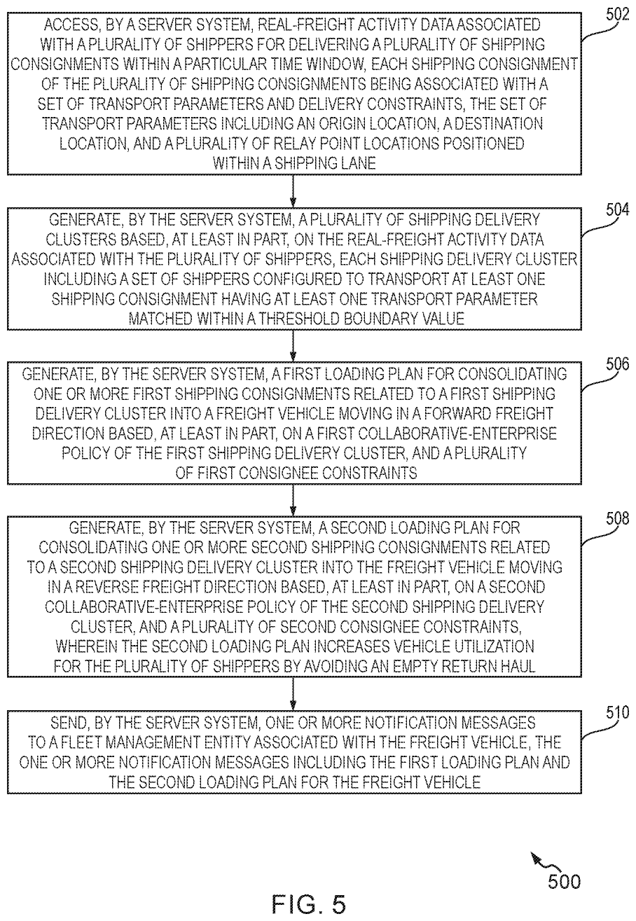

FIG. 5 shows a flow diagram of a computer-implemented method 500 for multi-enterprise freight load consolidation, in accordance with an embodiment of the invention. The various steps and/or operations of the flow diagram, and combinations of steps/operations in the flow diagram, may be implemented by, for example, hardware, firmware, a processor, circuitry and/or by an apparatus such as the server system 200 explained with reference to FIG. 2 and/or by a different device associated with the execution of software that includes one or more computer program instructions. The method 500 starts at operation 502.

At the operation 502, the method 500 includes accessing real-freight activity data associated with a plurality of shippers for delivering a plurality of shipping consignments within a particular time window. Each shipping consignment from the plurality of shipping consignments is associated with a set of transport parameters and delivery constraints and the set of transport parameters includes an origin location, a destination location and a plurality of relay point locations positioned within a shipping lane.

At operation 504, the method 500 includes generating a plurality of shipping delivery clusters based, at least in part, on the real-freight activity data associated with the plurality of shippers. Each shipping delivery cluster includes a set of shippers configured to transport at least one shipping consignment having at least one transport parameter matched within a threshold boundary value.

At 506, the method 500 includes generating a first loading plan for consolidating one or more first shipping consignments related to a first shipping delivery cluster into a freight vehicle moving in a forward freight direction. The freight vehicle is selected from the available freight vehicles based, at least in part, on loading characteristics of the freight vehicle and current location of the freight vehicle. The first loading plan is generated based, at least in part, on a first collaborative enterprise policy of the first shipping delivery cluster and a plurality of first consignee constraints.

At 508, the method 500 includes generating a second loading plan for consolidating one or more second shipping consignments related to a second shipping delivery cluster into the freight vehicle moving in a reverse freight direction based, at least in part, on a second collaborative enterprise policy of the second shipping delivery cluster, and a plurality of second consignee constraints. In at least some embodiments, the second loading plan is generated based on a forward transit time of the freight vehicle required for delivering the one or more first shipping consignments and available vehicle capacity of the freight vehicle. The second loading plan increases vehicle utilization for the plurality of shippers by avoiding an empty return haul.

At 510, the method 500 includes sending one or more notification messages to a fleet management entity associated with freight vehicle, the one or more notification messages including the first and second loading plans for the freight vehicle.

Various embodiments disclosed herein provide numerous advantages. More specifically, the embodiments disclosed herein suggest techniques for optimizing delivery of consignments to intended consignees. The loading plan for forward freight and reverse freight consolidation ensures that the stacking norms set at each delivery/material level are adhered to minimise the damages. The loading plan also ensures that the arrangement of materials is optimised for minimal loading and unloading time. All permissible routes considered while consolidation and the best possible route to reduce the overall distance travelled is suggested. Further, the generated loading plan maximizes capacity utilization of vehicles and minimizes the delivery cost for transferring the packages to multiple consignee locations. Such techniques significantly reduce the man-hours required for planning the freight movements across to different consignee locations. Moreover, this optimized way of shipping packages significantly reduces the overall cost, increases customer satisfaction and drives ecologically sensitive decisions.

Although the present invention has been described with reference to specific exemplary embodiments, it is noted that various modifications and changes may be made to these embodiments without departing from the broad spirit and scope of the present invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 200 and its various components such as the processor 202, the memory 204, the I/O module 206, the communication module 208 and the storage module 210 may be enabled using software and/or using transistors, logic gates, and electrical circuits (for example, integrated circuit circuitry such as ASIC circuitry). Various embodiments of the present invention may include one or more computer programs stored or otherwise embodied on a computer-readable medium, wherein the computer programs are configured to cause a processor or computer to perform one or more operations (for example, operations explained herein with reference to FIG. 5). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein with reference to FIG. 5. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (Blu-ray (registered trademark) Disc), and semiconductor memories (such as mask ROM, PROM (programmable ROM), EPROM (erasable PROM), flash ROM, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the present invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the present invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method (500) performed by a server system, the server system comprising a processor and a memory, the computer-implemented method (500) comprising:
accessing, by the server system (200), real-freight activity data associated with a plurality of shippers for delivering a plurality of shipping consignments within a particular time window, each shipping consignment of the plurality of shipping consignments being associated with a set of transport parameters and delivery constraints, the set of transport parameters comprising an origin location, a destination location, and a plurality of relay point locations positioned within a shipping lane;
predicting, by the server system (200), demand profiles of each shipper from among the plurality of shippers for the particular time window based, at least in part, on a machine learning model, wherein the machine learning model is a recurrent neural network model trained based at least on historical traffic pattern data and transit time across different shipping lanes;
generating, by the server system (200), a plurality of shipping delivery clusters based, at least in part, on the real-freight activity data associated with the plurality of shippers, each shipping delivery cluster comprising a set of shippers configured to transport at least one shipping consignment having at least one transport parameter matched within a threshold boundary value, wherein generating the plurality of shipping delivery clusters comprises:
clustering, by the server system (200) using a multi-clustering algorithm, candidate shippers into a shipping delivery cluster based, at least in part, on the predicted demand profiles, delivery routes and time windows for delivering multiple shipping consignments of the candidate shippers, wherein the multi-clustering algorithm is a combination of at least a hierarchical clustering algorithm and an iterative K-Means clustering algorithm;
generating, by the server system (200), a first loading plan for consolidating one or more first shipping consignments related to a first shipping delivery cluster into a freight vehicle moving in a forward freight direction based, at least in part, on a first collaborative enterprise policy of the first shipping delivery cluster, and a plurality of first consignee constraints, wherein generating the first loading plan comprises:
simulating, by the server system (200), a plurality of episodes iteratively based on a meta-heuristic method, wherein each episode from among the plurality of episodes entails a probable combination of consolidation of shipping consignments associated with the first shipping delivery cluster; and
determining, by the server system (200), the first loading plan associated with a lowest loading plan cost for forward freight consolidation based on the simulation of the plurality of episodes, wherein the lowest loading plan cost is computed by summing base freight charges and negative penalties for deviations of the plurality of first consignee constraints, the plurality of second consignee constraints and loading constraints;
generating, by the server system (200), a second loading plan for consolidating one or more second shipping consignments related to a second shipping delivery cluster into the freight vehicle moving in a reverse freight direction based, at least in part, on a second collaborative enterprise policy of the second shipping delivery cluster, and a plurality of second consignee constraints, wherein the second loading plan increases vehicle utilization for the plurality of shippers by avoiding an empty return haul; and
sending, by the server system (200), one or more notification messages to a fleet management entity associated with the freight vehicle, the one or more notification messages comprising the first loading plan and the second loading plan for the freight vehicle.

2. The computer-implemented method of claim 1, further comprising:
receiving, by the server system (200), information of available freight vehicles from the fleet management entity; and
selecting, by the server system (200), the freight vehicle from the available freight vehicles based, at least in part, on loading characteristics of the freight vehicle and a current location of the freight vehicle.

3. The computer-implemented method of claim 2, wherein a loading characteristic from among the loading characteristics of the freight vehicle corresponds to a material density capable of being accommodated in the freight vehicle and, wherein the freight vehicle is selected from the available freight vehicles based on material densities associated with the one or more first shipping consignments and the material density capable of being accommodated in the freight vehicle.

4. The computer-implemented method of claim 1, wherein each of the plurality of first consignee constraints and the plurality of second consignee constraints comprises at least:
consignee operating hours for reducing a vehicle wait time of the plurality of shippers,
consignee vehicle level restrictions based on a plurality of consignee locations for ensuring vehicle access, and
a stock keeping unit (SKU) mix to ensure that consignments with varying material properties are not transferred together in the freight vehicle.

5. The computer-implemented method of claim 1, wherein the first loading plan and the second loading plan are generated based, at least in part, on a maximum waiting time associated with each shipper for freight consolidation and loading constraints.

6. The computer-implemented method of claim 1, wherein the second loading plan is generated based, at least in part, on a forward transit time of the freight vehicle required for delivering the one or more first shipping consignments and available vehicle capacity of the freight vehicle.

7. The computer-implemented method of claim 1, wherein the first collaborative enterprise policy comprises a set of predefined rules for forward freight consolidation defined by shippers included in the first shipping delivery cluster.

8-10. (canceled)

11. The computer-implemented method of claim 1, further comprising:
determining, by the server system (200), whether the freight vehicle needs to be re-sized during at least one of a forward freight consolidation and a reverse freight consolidation based on upcoming demand.

12. A server system (200), comprising:
a memory (204) for storing instructions; and
a processor (202) configured to execute the instructions and thereby cause the server system to at least:
access real-freight activity data associated with a plurality of shippers for delivering a plurality of shipping consignments within a particular time window, each shipping consignment being associated with a set of transport parameters and delivery constraints, the set of transport parameters comprising an origin location, a destination location, and a plurality of relay point locations positioned within a shipping lane;
predict demand profiles of each shipper from among the plurality of shippers for the particular time window based, at least in part, on a machine learning model, wherein the machine learning model is a recurrent neural network model trained based at least on historical traffic pattern data and transit time across different shipping lanes;
generate a plurality of shipping delivery clusters based, at least in part, on the real-freight activity data associated with the plurality of shippers, each shipping delivery cluster comprising a set of shippers configured to transport at least one shipping consignment having at least one transport parameter matched within a threshold boundary value, wherein to generate the plurality of shipping delivery clusters, the server system is further caused to:
cluster, using a multi-clustering algorithm, candidate shippers into a shipping delivery cluster based, at least in part, on the predicted demand profiles, delivery routes and time windows for delivering multiple shipping consignments of the candidate shippers, wherein the multi-clustering algorithm is a combination of at least a hierarchical clustering algorithm and an iterative K-Means clustering algorithm;
generate a first loading plan for consolidating one or more first shipping consignments related to a first shipping delivery cluster into a freight vehicle moving in a forward freight direction based, at least in part, on a first collaborative enterprise policy of the first shipping delivery cluster, and a plurality of first consignee constraints, wherein to generate the first loading plan, the server system is further caused to:
simulate a plurality of episodes iteratively based on a meta-heuristic method, wherein each episode from among the plurality of episodes entails a probable combination of consolidation of shipping consignments associated with the first shipping delivery cluster; and
determine the first loading plan associated with a lowest loading plan cost for forward freight consolidation based on the simulation of the plurality of episodes, wherein the lowest loading plan cost is computed by summing base freight charges and negative penalties for deviations of the plurality of first consignee constraints, the plurality of second consignee constraints and loading constraints;
generate a second loading plan for consolidating one or more second shipping consignments related to a second shipping delivery cluster into the freight vehicle moving in a reverse freight direction based, at least in part, on a second collaborative enterprise policy of the second shipping delivery cluster, and a plurality of second consignee constraints, wherein the second loading plan increases vehicle utilization for the plurality of shippers by avoiding an empty return haul; and
send one or more notification messages to a fleet management entity associated with the freight vehicle, the one or more notification messages comprising the first loading plan and the second loading plan for the freight vehicle.

13. The server system of claim 12, wherein the server system is further caused to:
receive information of available freight vehicles from the fleet management entity; and
select the freight vehicle from the available freight vehicles based, at least in part, on loading characteristics of the freight vehicle and a current location of the freight vehicle.

14. The server system of claim 13, wherein a loading characteristic from among the loading characteristics of the freight vehicle corresponds to a material density capable of being accommodated in the freight vehicle and, wherein the freight vehicle is selected from the available freight vehicles based on material densities associated with the one or more first shipping consignments and the material density capable of being accommodated in the freight vehicle.

15. The server system of claim 12, wherein the first loading plan and the second loading plan are generated based, at least in part, on a maximum waiting time associated with each shipper for freight consolidation and loading constraints.

16. The server system of claim 12, wherein the second loading plan is generated based, at least in part, on a forward transit time of the freight vehicle required for delivering the one or more first shipping consignments and available vehicle capacity of the freight vehicle.

17. The server system of claim 12, wherein the first collaborative enterprise policy comprises a set of predefined rules for forward freight consolidation defined by shippers included in the first shipping delivery cluster.

18-20. (canceled)

21. A computer-implemented method (500) for multi-enterprise freight load consolidation and optimization, the computer-implemented method (500) comprising:
accessing, by a server system (200), real-freight activity data associated with a plurality of shippers for delivering a plurality of shipping consignments within a particular time window, each shipping consignment of the plurality of shipping consignments being associated with a set of transport parameters and delivery constraints, the set of transport parameters comprising an origin location, a destination location, and a plurality of relay point locations positioned within a shipping lane;
predicting, by the server system (200), demand profiles of each shipper from among the plurality of shippers for the particular time window based, at least in part, on a recurrent neural network model that is trained based at least on historical traffic pattern data and transit time across different shipping lanes;
clustering, by the server system (200), candidate shippers into a shipping delivery cluster of a plurality of shipping delivery clusters based, at least in part, on the predicted demand profiles, delivery routes and time windows for delivering multiple shipping consignments of the candidate shippers, each shipping delivery cluster comprising a set of shippers configured to transport at least one shipping consignment having at least one transport parameter matched within a threshold boundary value, wherein the multi-clustering algorithm is a combination of at least a hierarchical clustering algorithm and an iterative K-Means clustering algorithm;
selecting, by the server system (200), a first shipping delivery cluster including a set of shippers having one or more first shipping consignments to be delivered in a shipping lane;
simulating, by the server system (200), a plurality of episodes iteratively based on a meta-heuristic method, wherein each episode from among the plurality of episodes entails a probable combination of consolidation of the one or more shipping consignments determined based, at least in part, on a first collaborative enterprise policy of the first shipping delivery cluster, and a plurality of first consignee constraints;
determining, by the server system (200), a first loading plan for consolidating the one or more first shipping consignments related to the first shipping delivery cluster into a freight vehicle moving in a forward freight direction based on the simulation of the plurality of episodes, wherein the lowest loading plan cost is computed by summing base freight charges and negative penalties for deviations of the plurality of first consignee constraints, the plurality of second consignee constraints and loading constraints;
determining, by the server system (200), a second loading plan for consolidating one or more second shipping consignments related to a second shipping delivery cluster into the freight vehicle moving in a reverse freight direction of the shipping lane based, at least in part, on a second collaborative enterprise policy of the second shipping delivery cluster, and a plurality of second consignee constraints, wherein the second loading plan increases vehicle utilization for the plurality of shippers by avoiding an empty return haul; and
sending, by the server system (200), one or more notification messages to a fleet management entity associated with the freight vehicle, the one or more notification messages comprising the first loading plan and the second loading plan for the freight vehicle.
